(19) United States
(12) Patent Application Publication
(10) Pub. No.: US 2006/0198718 A1
(43) Pub. Date: Sep. 7, 2006

(54) Mounting nail

(76) Inventor: Tung-I Chen, Taichung Hsien (TW)

Correspondence Address: LEONG C LEI, PMB # 1008, 1867 YGNACIO VALLEY ROAD, WALNUT CREEK, CA, 94598, US

(21) Appl. No.: 11/185,893

(22) Filed: Sep. 12, 2005

(30) Foreign Application Priority Data
Mar. 2, 2005 (TW) 094203194

(51) Int. Cl. F16B 15/06

(52) U.S. Cl. 411/475; 411/456

(57) ABSTRACT

A mounting nail is disclosed. The nail has a nail body and the edge around the nailing leg of the nail is formed into protruded section facing upward. The protruded section corresponding to the upper surface of the nailing leg and the nailing leg corresponding to the circumferential face has an inclination angle of less than 90 degree, and the lower surface of the protruded section is upwardly inclined. When a mounting nail is mounted into an object, the protruded section will hook onto the object. Thus, the object is secured and fastened without dislocation.

### BACKGROUND OF THE INVENTION

(a) Technical Field of the Invention

The present invention relates to a mounting nail, which is used to bind two objects together, and in particular, a mounting nail which can be smoothly mounted into objects.

(b) Description of the Prior Art

Conventional mounting nail for binding two objects includes nail body having a T-shape, I-shape, U-shape or “inverted U-shape”. As shown in FIGS. 1A & 1B, the mounting nail has a wire-pressing body 10 having an “inverted U-shaped” nail body 15. The two sides of the body 15 are extended to form the nailing leg 16. The circumferential edge of the nailing leg 16 is smooth and when such a mounting nail is mounted into an object, the contact surface is straight and this affects the securing force of the nail body 15. Thus, when the nailing leg 16 is loosen, or when the wire-pressing body 10 presses a wire, the resilient force of the plastic material of the wire may cause the nailing leg to be dislocated. To solve this drawback, as shown in FIGS. 2A & 2B, grooves 27 are formed at the nailing leg 26, and therefore, when the nail body 25 is mounted into an object, the grooves 27 will force a resistance with the wall of the object. However, when the nail body 25 is within an object, the grooves 27 are not fully occupied by the material of the objects, and therefore, securing of the mounting nail to the wall of the object is very limited. Accordingly, it is an object of the present invention to provide a mounting nail which solves the above drawback and can firmly secure two objects together.

### SUMMARY OF THE INVENTION

The primary purpose of the present invention is to provide a mounting nail structure having a nail body extended downwardly to form a nailing leg with a series of protrusions along the circumferential edge, characterized in that the protrusion is inclined upward, and the inclination angle between the nailing leg and the circumferential face and the upper surfaces corresponding to the protrusion is not exceedingly 90 degree so that the protrusion is extended outward, thereby when the mounting nail is mounted into an object, the nail is smoothly mounted and the outwardly extended protrusion will prevent the mounting nail from dislocation.

Yet still another object of the present invention is to provide a mounting nail, wherein the nail body is inverted U-shaped, T-shaped, U-shaped and I-shaped body.

Sill another object of the present invention is to provide a mounting nail, wherein the protrusion is formed by a plurality of notches or slots.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIGS. 1A & 1B shows a sectional view of a conventional mounting nail.

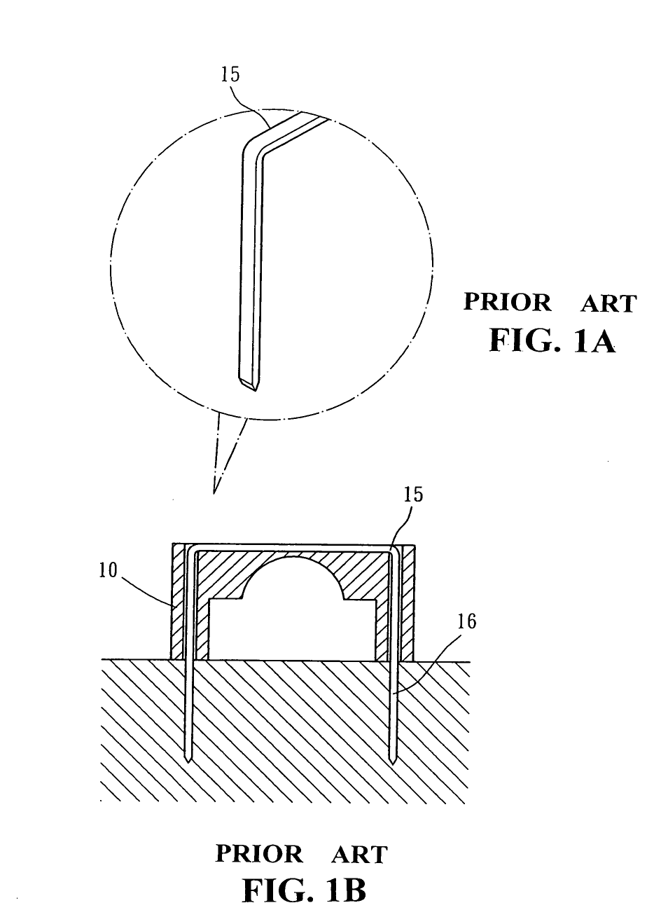

FIGS. 2A & 2B shows a sectional view of another conventional mounting nail, having a T-shaped nail body at both sides of the wire pressing body.

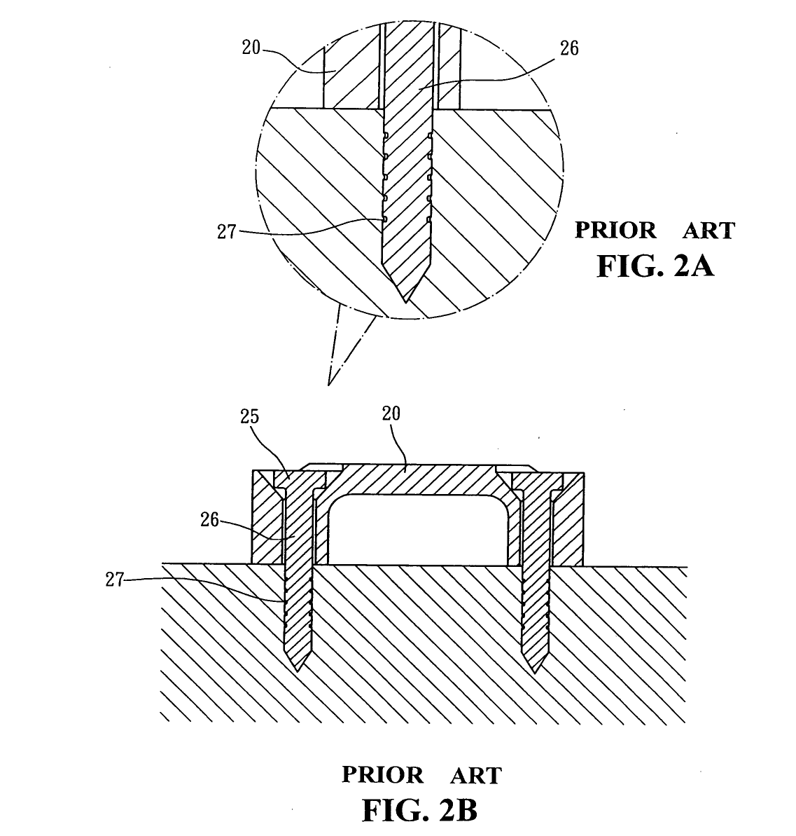

FIGS. 3A & 3B is a sectional view showing the mounting nail in accordance with the present invention, wherein the downwardly extended nailing pin is provided with a protrusion.

FIGS. 4A & 4B is a sectional view showing the mounting nail in accordance with the present invention.

FIGS. 5A & 5B is a sectional view showing another preferred embodiment of the mounting nail in accordance with the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

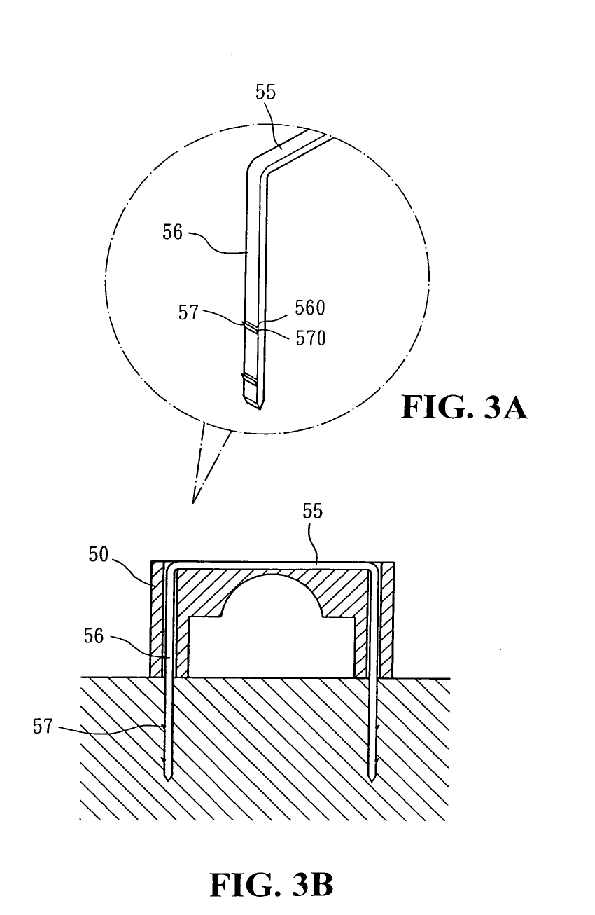

Referring to FIGS. 3A & 3B, there is shown a mounting nail structure for binding two objects together. The mounting nail includes a nailing body having a wire-pressing body 50. The wire-pressing body 50 is provided horizontally an “inverted U-shaped” nailing body 55. When the wire-pressing body 50 presses against a wire, an “inverted U-shaped” nailing body 55 secures the wire-pressing body 50 onto the ground or other surface.

As shown in FIGS. 3A & 3B, the two ends of the “inverted U-shaped” nailing body 55 are bent downward and extended to form a nailing leg 56. The external edge of the two nailing legs 56 is provided with protrusions 57. The protrusions 57 are upwardly inclined, and the circumferential face 560 and the upper surface 570, corresponding to the nailing legs 56 and the protrusion 57 is the inclination angle, which is less than 90 degree, such that the protrusion 57 is slightly extended.

When the nailing body 55 is mounted onto an object, the protrusion 57 is inclined upward and therefore, when the nailing body is within the object, the protrusion 57 will be converged and this will not affect the nailing body 55 from entering an object. However, the restoration force of the protrusion 57 being extended outward and this will secure the two objects together without dislocation.

FIGS. 3A & 3B shows the exact application of the mounting nail of the present invention. When the wire-pressing body 50 clips onto the wire, the nailing body 55 presses against the wire-pressing body 56 onto the ground or other flat surface. When the nailing body 55 is mounted onto an object, the protrusion 57 being upwardly inclined will converge against an applied force. This will not retard or resist the nailing body 55 from entering an object. When the nailing body 55 is at a secured position, the restoration force of the protrusion 57 will cause the protrusion 57 to extend outward so that the nailing body 55 is secured with the object. This will cause the two objects to be mounted firmly.

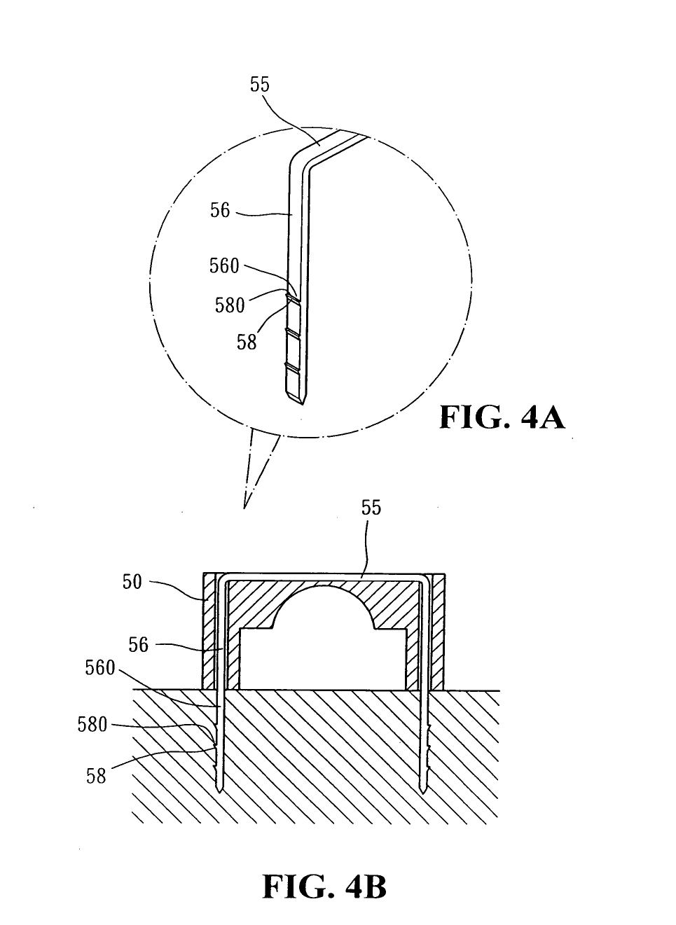

FIGS. 4A & 4B is another preferred embodiment in accordance with the present invention. The wire-pressing body 50 is provided horizontally with a nailing body 55 and the two ends of the nailing body 55 are bent downwardly to form nailing leg 56. The outer circumferential edge of the two nailing legs 56 is a series of protrusions 58 which are conic shaped. The circumferential face 560 of the nailing legs 56 and the upper surface of the protrusion 58 being an inclination angle of less than 90 degree, such that when the protrusion 58 is extended outward. In accordance with this design, when the nailing body 55 is inserted into an object, the lower surface of the protrusion 58 shows an inclined sloping face, and this will not retard or resist the nailing body 55 enters the object. After the nailing body 55 is inserted, the two objects are secured.

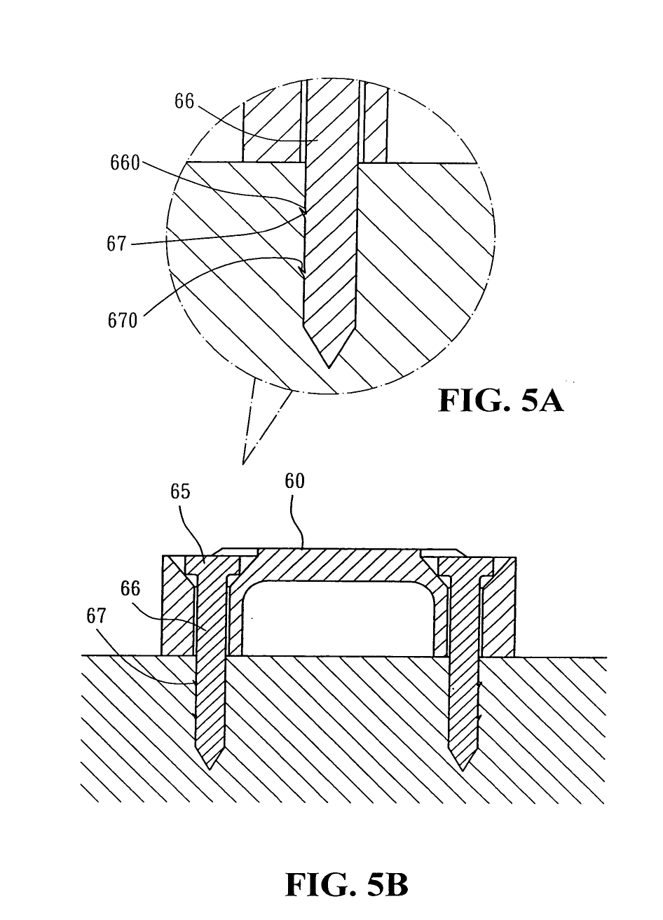

Referring to FIGS. 5A & 5B, the two sides of the wire-pressing body 60 have a T-shaped nailing body 65, and the circumferential edge of the nailing legs 66 is provided with a plurality of protrusions 67 which is formed by a series of notches. The protrusion 67 is an upwardly inclined structure, and the circumferential face 660 and the upper surface 670 corresponding to the nailing leg 66 and the protrusion 67 has an inclined angle of less than 90 degree, such that the protrusion 167 is slightly extended outward. The T-shaped nailing body 65 is similarly functioned as that of the “inverted U-shaped” nailing body 55.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A mounting nail structure having a nail body extended downwardly to form a nailing leg with a series of protrusions along the circumferential edge, characterized in that the protrusion is inclined upward, and the inclination angle between the nailing leg and the circumferential face and the upper surfaces corresponding to the protrusion is not exceedingly 90 degree so that the protrusion is extended outward, thereby when the mounting nail is mounted into an object, the nail is smoothly mounted and the outwardly extended protrusion will prevent the mounting nail from dislocation.

2. The mounting nail of claim 1, wherein the nail body is inverted U-shaped, T-shaped, U-shaped and I-shaped body.

3. The mounting nail of claim 1 or 2, wherein the protrusion is formed by a plurality of notches or slots.

4. The mounting nail of claim 1 or 2, wherein the protrusion of the nail body is form as a unit with the nail body.
